(19) United States
(12) Patent Application Publication
(10) Pub. No.: US 2006/0179905 A1
(43) Pub. Date: Aug. 17, 2006

(54) Latch protector

(76) Inventor: Don Killins, Monroe, LA (US)

Correspondence Address: LITMAN LAW OFFICES, LTD, PO BOX 15035, CRYSTAL CITY STATION, ARLINGTON, VA, 22215, US

(21) Appl. No.: 11/354,165

(22) Filed: Feb. 15, 2006

Related U.S. Application Data
(60) Provisional application No. 60/653,107, filed on Feb. 16, 2005.

(51) Int. Cl. E05B 15/02

(52) U.S. Cl. 70/418

(57) ABSTRACT

The latch protector is a flat, rectangular plate having an angled lip at one end of the plate. The plate has a hole that is dimensioned to allow for passage of a knob bushing of a doorknob. The latch protector is made of metal or a durable plastic. The latch protector prevents an intruder from tampering with the lock spring mechanism or bolt assembly, which is shielded by the protector. The latch protector is installed by placing the latch protector between the escutcheon of a doorknob and the door so that the angled lip protrudes over the edge of the door. No screws, rivets, or anchoring systems are needed to install the latch protector. The latch protector may be used on doors having locking assemblies on either the right or left hand side of the door.

### CROSS-REFERENCE TO RELATED APPLICATION

This application claims the benefit of U.S. Provisional Patent Application Ser. No. 60/653,107, filed Feb. 16, 2005.

### BACKGROUND OF THE INVENTION

1. Field of the Invention

The present invention relates to a door lock guard, and particularly to a latch protector plate that is attached to a door of a mobile home or utility shed in order to prevent unauthorized entry.

2. Description of the Related Art

Many door-locking mechanisms utilize a retractable spring-loaded latch assembly operated by a knob on either side of the door. The doorjamb is equipped with a strike plate and a socket. When the door is closed, the latch is pushed inward by the strike plate until the latch aligns with the socket and springs outward. Unfortunately, door-locking mechanisms using spring-loaded latch assemblies can be breached by various methods. For example, the latch may be disengaged by sliding a slim strip of plastic or metal between the door and the doorjamb to push the latch back from the socket. Alternatively, a screwdriver or crowbar may be used to pry the latch from the socket by spreading out the doorframe and then simply pushing or kicking the door open.

The problems associated with unauthorized entry through doors with spring-loaded latch assemblies are particularly troublesome on mobile homes and utility sheds. Additional security measures, such as deadbolts, alarm systems, or security doors, are often too cumbersome and expensive to be a viable option for a mobile home or a utility shed. In addition, the installation of some security systems is designed to be permanent, and therefore not well adapted to temporary or mobile housing or storage units. Because many mobile homes and utility sheds are constructed from aluminum or other metal siding, drilling holes to attach security measures is usually undesirable.

Devices known as latch guards have been proposed, that comprise a protective plate attached to the door and that overlies the seam in the door assembly over the latch in order to prevent tampering with the latch. Latch guards have proven to be an effective security measure, although they too have problems with installation. Many latch guards must be custom designed to suit different types of doorknobs, doors, and doorjambs, which is both time consuming and expensive. Many latch guards require holes to be drilled in the door and an anchoring system. Further, the doorframe on many mobile homes has an outward surface that contains a channel or is otherwise recessed. Thus, a latch protector that is adapted for use on a mobile home or a utility shed solving the aforementioned problems is desired.

### SUMMARY OF THE INVENTION

The latch protector is a flat, rectangular plate having an angled lip at one end of the plate. The plate has a hole that is dimensioned to allow for passage of a doorknob spindle, but is smaller in diameter than the exterior escutcheon, also sometimes referred to as a rose, rosette, or cover plate. The latch protector is made of metal or a durable plastic. The latch protector is designed to prevent an intruder from gaining access to a door through the use of a crowbar or other tools. The protector is adapted for use on the doors of mobile homes and utility sheds that have doorjambs with an exterior channel. The lip extends into the channel in the doorjamb and prevents an intruder from tampering with the lock spring mechanism or bolt assembly, which is shielded by the protector.

To install the latch protector, a user first removes the doorknob and the escutcheon from the door lockset. The latch protector is then placed over the spindle. The latch protector is positioned so that the plate is flush to the door and the lip protrudes past the edge of the door. The latch protector is held in place by re-installing the escutcheon, which clamps the latch protector in place. The last step is to attach the doorknob. No screws, rivets, or anchoring systems are needed to install the latch protector. The latch protector may be used on doors having locking assemblies on either the right or left hand side of the door.

These and other features of the present invention will become readily apparent upon further review of the following specification and drawings.

### BRIEF DESCRIPTION OF THE DRAWINGS

FIG. 1 is an environmental, perspective view of a latch protector according to the present invention.

FIG. 2 is a perspective view of the latch protector according to the present invention.

FIG. 3 is an exploded, environmental perspective view of the latch protector of the present invention attached to a door.

FIG. 4 is a front view of the latch protector according to the present invention.

FIG. 5 is a top view of the latch protector according to the present invention.

Similar reference characters denote corresponding features consistently throughout the attached drawings.

### DETAILED DESCRIPTION OF THE PREFERRED EMBODIMENT

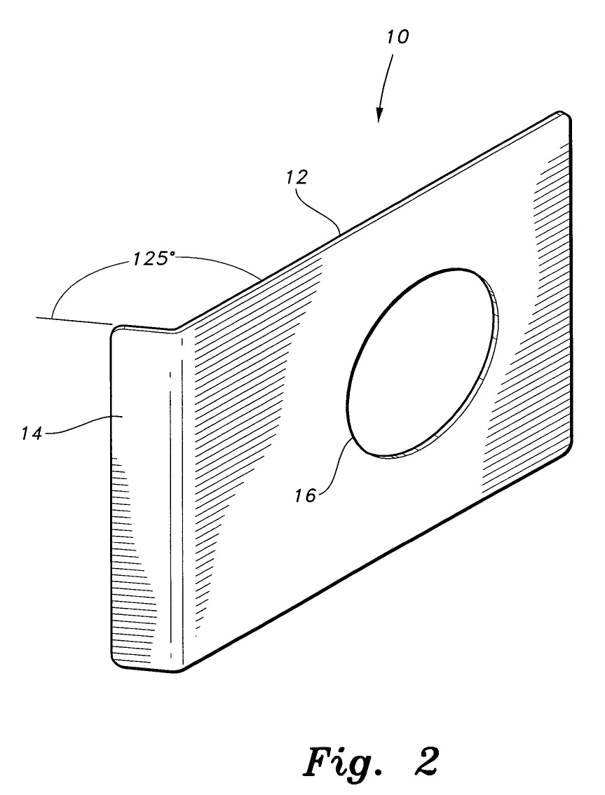

The present invention is a latch protector, designated generally as 10 in the drawings and referred to as the “protector” herein. Referring to FIG. 2, the protector 1 0 comprises a flat, rectangular plate 12 having an angled lip 14 at one end of the plate 12. The plate 12 has a hole 16 that is dimensioned to allow for passage of a doorknob spindle. Although the hole 16 is shown as a circular hole in the drawings, it will be understood that the hole may have any desired shape, e.g., the hole 16 may be square.

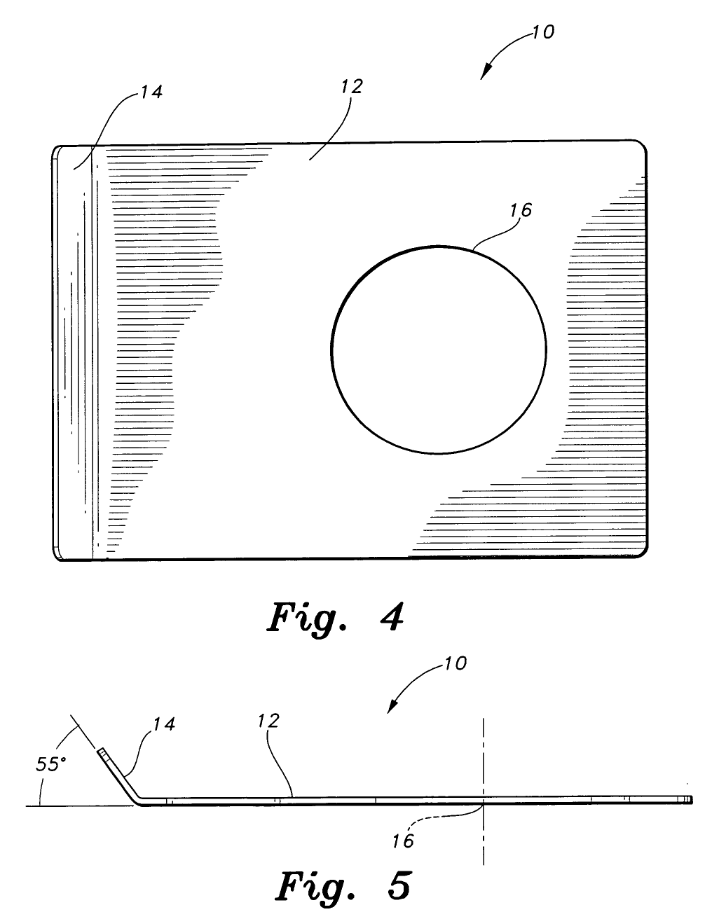

The protector 10 is made of metal or a durable plastic. In the preferred embodiment, the protector 1 0 is constructed of 12-gauge or 16-gauge stainless steel. The plate 12 has a length (from side to side) of approximately 5- 3/16″ and a width (from top to bottom) or height of about 4″-5″. As shown in FIGS. 4 and 5, the lip 16 is formed at an angle of between about 30° and 60°, preferably about 55°, to the plane of the plate 12. The lip has a length of 9/16″ and a width of about 4″-5″, which is substantially co-extensive with the width or height of the plate.

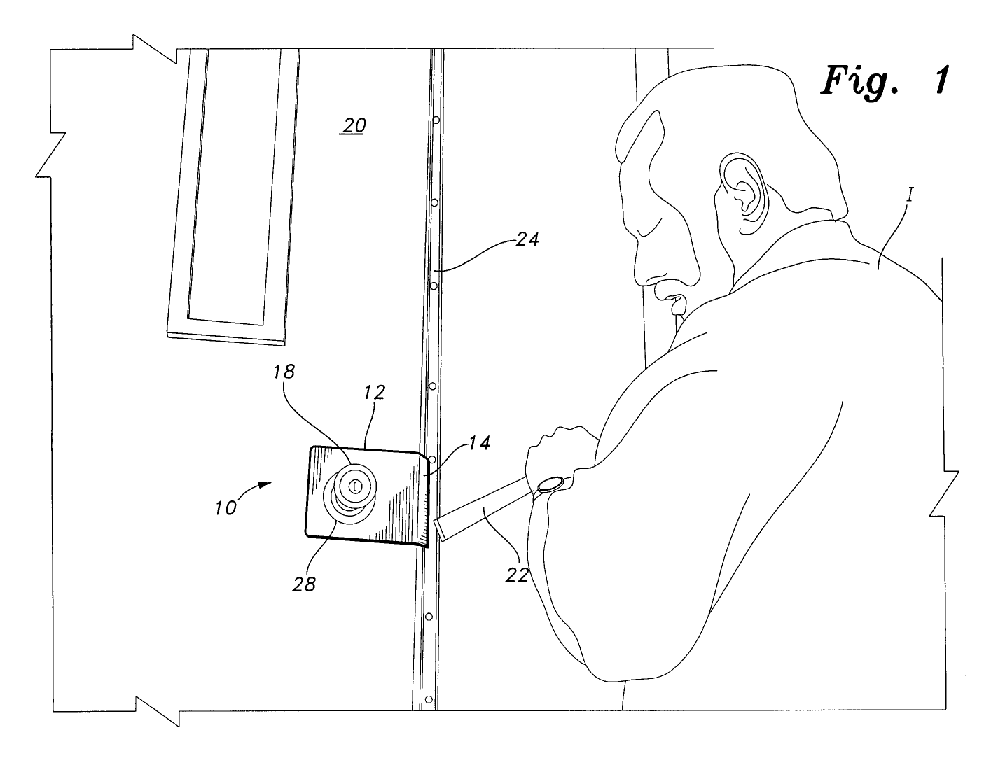

Referring to back FIG. 1, the protector 10 is designed to prevent an intruder I from gaining access to a mobile home or utility shed through a door 20 by the use of a crowbar 22 or other tools. The protector 10 is designed for use in conjunction with doors 20 having the type of doorjamb 24 shown in FIG. 1. The doorjamb 24 has a channel facing the exterior of the structure, as is common in the type of door assembly used on utility sheds and mobile homes. The lip 14 extends into the channel in the doorjamb 24 and prevents an intruder I from tampering with the lock spring mechanism or bolt assembly, which is shielded by the protector 10.

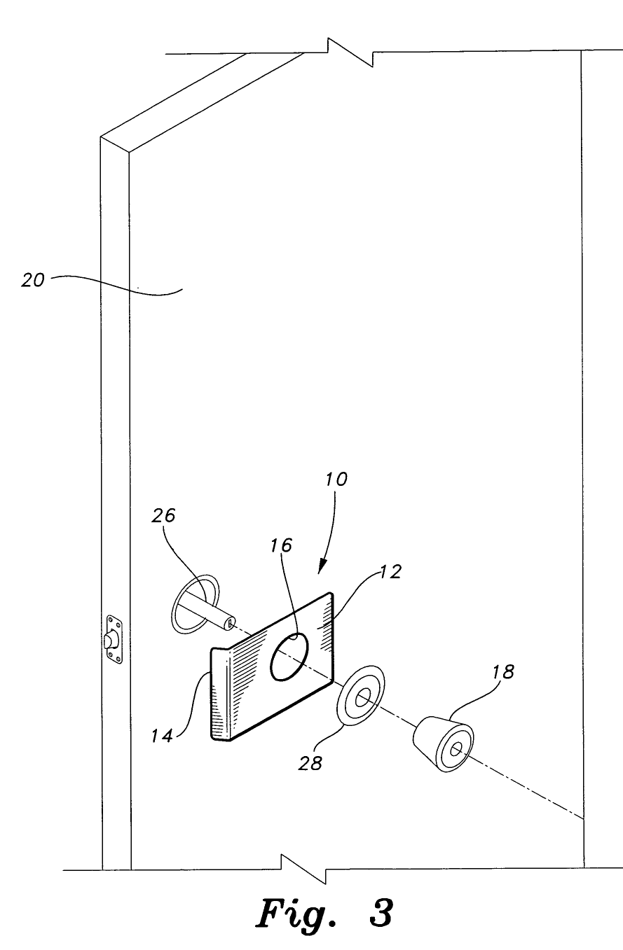

Installation of the protector 10 is illustrated in FIG. 3. The doorknob 18 and the escutcheon 28 are removed from the lockset. The protector 10 is then placed over the doorknob spindle 26 or shaft. The protector 10 is positioned so that the plate 12 is flush to the door 20 and the lip 14 protrudes past the edge of the door 20. The protector 10 is held in pace by re-installing the escutcheon 28, which clamps the protector 10 in place, since the escutcheon 28 has a larger diameter than the hole 16 defined in the protector 10. The last step is to attach the doorknob 18. No screws, rivets, or anchoring systems are needed to install the protector 10. The protector 10 may be used on doors having locking assemblies on either the right or left hand side of the door 20.

It is to be understood that the present invention is not limited to the embodiments described above, but encompasses any and all embodiments within the scope of the following claims.

I claim:

1. A latch protector for preventing forced entry through a closed door by separating a knob-operated latch from a doorjamb having an external channel, the latch protector comprising a flat rectangular plate having an angled lip dimensioned and configured to fit into the channel of the doorjamb, the plate having a hole defined therein dimensioned and configured for passage of a doorknob spindle therethrough, the plate being adapted for clamping between a lockset escutcheon and the door.

2. The latch protector according to claim 1, wherein the plate and the lip form an angle of between about 30° and 60°.

3. The latch protector according to claim 1, wherein the plate and the lip form an angle of about 55°.

4. The latch protector according to claim 1, wherein said plate is made from stainless steel.

5. The latch protector according to claim 1, wherein the rectangular plate and the angled lip are co-extensive in width.

6. The latch protector according to claim 1, wherein the hole in said plate is circular.

7. The latch protector according to claim 1, wherein the hole in said plate is square.

8. A lockset with latch protector, comprising:
a lockset having a pair of opposing doorknobs, a spindle extending between the doorknobs and dimensioned and configured to extend through a door, a latch operatively connected to the spindle, a lock plate adapted for attachment to a door jamb, the latch engaging and disengaging the lock plate when one of the doorknobs and the spindle are rotated, a lock mechanism mounted in the doorknobs operative to selectively prevent the latch from disengaging the lock plate in the locked position, and an escutcheon disposed over the spindle adapted for securing the lockset to the door; and
a rectangular plate having an angled lip and a single hole defined therein, the plate being positioned over the spindle with the spindle extending through the single hole, the plate being adapted for being clamped between the escutcheon and the door with the angled lip extending into a gap between the door and the door jamb and overlying the latch, the rectangular plate forming a latch protector in order to prevent the latch from being pried out of the lock plate when the lock is in the locked position.

9. The lockset according to claim 8, wherein the plate and the lip form an angle of between about 45° and 60°.

10. The lockset according to claim 8, wherein the plate and the lip form an angle of about 55°.

11. The lockset according to claim 9, wherein said plate is made from stainless steel.

12. The lockset according to claim 8, wherein the rectangular plate and the angled lip are co-extensive in width.

13. The lockset according to claim 8, wherein the hole in said plate is circular.

14. The lockset according to claim 8, wherein the hole in said plate is square.
